(19) United States
(12) Patent Application Publication
(10) Pub. No.: US 2009/0031203 A1
(43) Pub. Date: Jan. 29, 2009

(54) HYPERLINKS

(75) Inventors: Praphul Chandra, Bangalore (IN); Shekhar Ramachandra Borgaonkar, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P.

(21) Appl. No.: 11/874,462

(22) Filed: Oct. 18, 2007

(30) Foreign Application Priority Data
Jul. 26, 2007 (IN) 1615/CHE/2007

(51) Int. Cl. G06F 15/00

(52) U.S. Cl. 715/205

(57) ABSTRACT

A method of creating hyperlinks from an electronic document and for accessing printed hyperlinks is described. A document 12 including URLs is printed as printed document 24. Image information 28 from the hyperlink location 26 is extracted and saved together with URL information 18 in database 30. To access the hyperlink, a reader captures an image of the hyperlink information and uses this to query database 30 which returns hyperlink information 18.

### FIELD OF THE INVENTION

This invention relates to the field of hyperlinks.

### BACKGROUND

Both paper and electronic media shall continue to exist for some time, using “paper” as a shorthand to include other non-electronic media. To communicate information about electronic media on paper or other non-electronic media the conventional approach is to simply print a universal resource locator (URL) as part of text. However, such an approach is not ideal since it breaks up the flow of text. Moreover, it is far from convenient for a reader to have to type a complex URL into a web browser to access electronic content.

### BRIEF DESCRIPTION OF THE DRAWINGS

For a better understanding of the invention, embodiments will now be described, purely by way of example, with reference to the accompanying drawings, in which:

FIG. 1 is a flow diagram of a method of generating hyperlinks printing an image;

FIG. 2 is a diagram of apparatus for generating hyperlinks while printing an image;

FIG. 3 is a diagram of apparatus for accessing a hyperlink from a printed document;

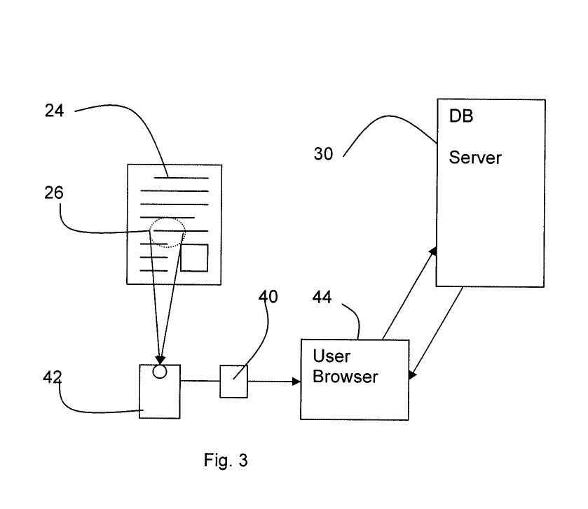

FIG. 4 is a flow diagram of a method of accessing a hyperlink from a printed document; and

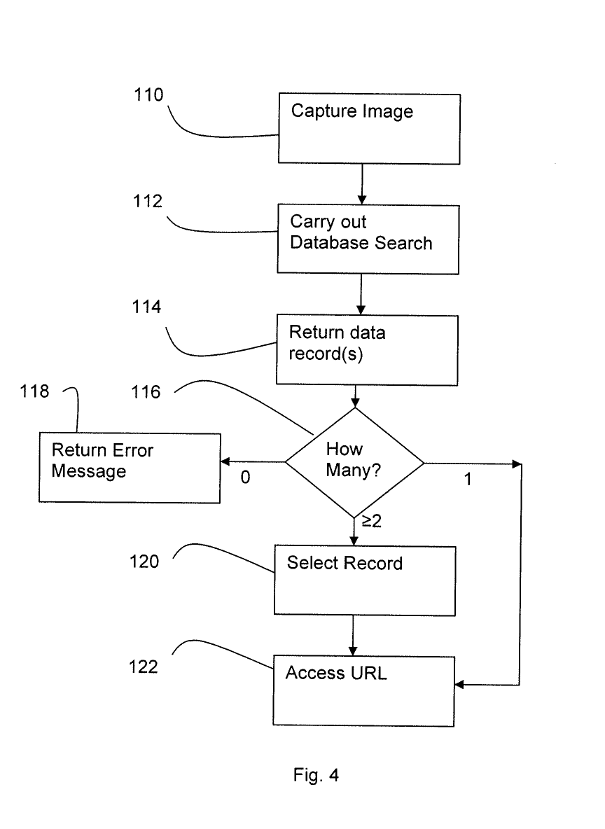

FIG. 5 is a diagram of an alternative apparatus for generating hyperlinks.

### DETAILED DESCRIPTION

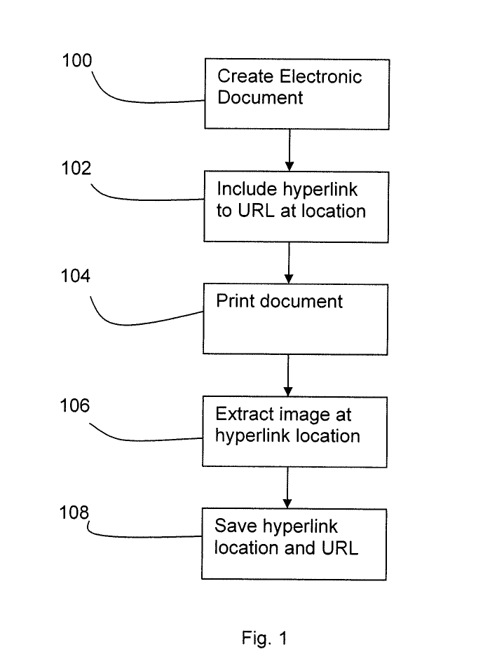

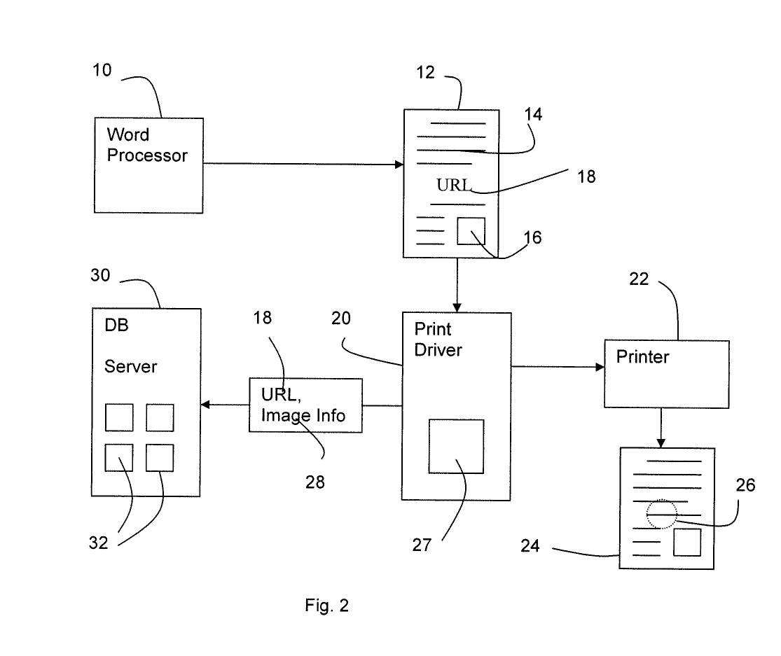

Referring to FIGS. 1 and 2, a user creates 100 an electronic document 12 using conventional editing tools 10 on a computer. In the example, the document 12 includes both text 14 and images 16. In order to include a hyperlink the user adds 102 a web-address 18 in the form of a URL to the electronic document 12 and this is stored in the electronic document at a particular location. The URL might be, for example http://government.hp.com/solutions_detailTabs.asp?sid=32&tab=0&agencyid=0&iumpid=in_R33_psg_solution_green_PS_primaryB1.

More usually, the hyperlink is embedded electronically in the text but displayed in a different human readable form. For example, the link mentioned in the previous paragraph might be represented as HP's Green Solutions in the displayed text with the underlining indicating the hyperlink. The text displayed and the electronic URL accordingly do not match.

When accessing the document in its electronic form, it is relatively straightforward to simply click on the electronic hyperlink and hence access the web address 18. However, once an electronic document containing embedded URLs is printed, the information regarding the URL is lost. Furthermore, even if the URL is not embedded and is available in the print, it would be extremely time consuming for a reader to type in such a link on a separate web browser. Many links are very long and impractical to type in.

Accordingly, to create a copy of the electronic document on paper, the user prints out 104 the electronic document using print driver 20 and printer 22 to create a printed document 24.

In the case of an embedded hyperlink, the displayed text is simply printed out and the underlying URL is not. No tag, bar code or other printed data structure representing the URL is added at the location of the URL.

Instead, as part of the print process, the image at the particular location 26, i.e. the location from which the URL is detected 106 from the electronic document is extracted. The location is shown in FIG. 2 on printed document 24 but in the embodiment the image at the location 26 is extracted by the print driver 20 before the document is actually printed.

In more detail, what occurs is that an electronic image 27 is created corresponding to the printed document, i.e. without the URL. Then, this electronic image 27 is processed in the print driver 20 and image information 28 representing the image at the particular location 26 is extracted. The image information 28 is then passed to database 30 together with the URL 18 and saved 108 as a database record 32.

The electronic image 27 is then passed to printer 22 for printing as document 24.

For documents containing multiple hyperlinks, each hyperlink creates a separate database entry 32 each including image information 28 and respective URL 18.

When a reader wants to access the URL from the printed page, the user simply captures 110 a captured image 40 of the relevant part of the printed document 104 using a camera 42, for example, a camera integrated onto a mobile device.

The captured image 40 is then passed to a processor 44, which may be on the mobile device itself or another device. The image information 28 representing the image at the particular location 26 is extracted. In the example the processor is a user web browser. The processor then accesses database 30 and sees if any of the database entries 32 include image information 28 corresponding to captured image 40. The database 30 then returns 114 one, none, or more than one data records that match the captured image.

If exactly one record 32 has matching image information 28, the processor 44 uses the corresponding URL 18 in that record.

If multiple records 32 have matching image information 28, the user is given the choice which web address the user requires, by displaying the URLs 18 found. The user can then select 120 one URL and the processor 44 uses the selected URL 18.

If no image information 28 is found corresponding to the captured image 40, the processor 44 outputs 118 an indication that no link is found.

The features used as image information 28 may include word lengths, word shapes, word color, and other features as required. The context may be used, i.e. information about the user or the document may be used to narrow down the search.

By printing out a hyperlinked document 12 in this way, the printed copy 26 effectively has hyperlinks without interrupting the flow of text or images of the printed copy with long strings of characters or other hyperlink tags.

The process is much faster and easier than any prior art approach that requires a bar code to be printed and the user to have a bar code reader.

A further major benefit of the embodiment is that existing electronic documents can simply be printed out to generate the hyperlinked paper documents—there is no need for further processing other than a “print” command.

It is as easy to access the hyperlink 18 from the paper copy of a document as from the electronic copy.

The method described is much better than the alternative of providing keywords in the paper document and allowing the user to search in a search engine for the content. Many users are not able to search efficiently, especially if the user does not know any suitable exact keywords. The results of such searching can result in too many documents. A search on Google for “World war 11”, for example, results in over one hundred million results which is far too many to review individually.

There are a number of suitable ways for recording and accessing the image information relating to the hyperlink location in the document. In particular, Nakai et al, in “Camera-Based Document Image Retrieval as Voting for Partial Signatures of Projective Invariants”, Proceedings of the 2005 Eighth International Conference on Document Analysis and Recognition, describe a suitable method. Further details from the same authors are provided in Nakai et al, “Hashing with Local Combinations of Feature Points and Its Application to Camera-Basd Document Image Retrieval”, presently available on the internet at: http://www.m.cs.osakafu-u.ac.jp/publication_data/369.pdf.

Other image classification and search algorithms may be used if required.

In the embodiment described above, the processing to extract the image information 28 as the takes place in the print driver 20 which acts as a means to extract image information.

However, in an alternative arrangement, the processing takes place in the software, firmware or in software of the printer 22 itself, which again acts as a means to extract image information.

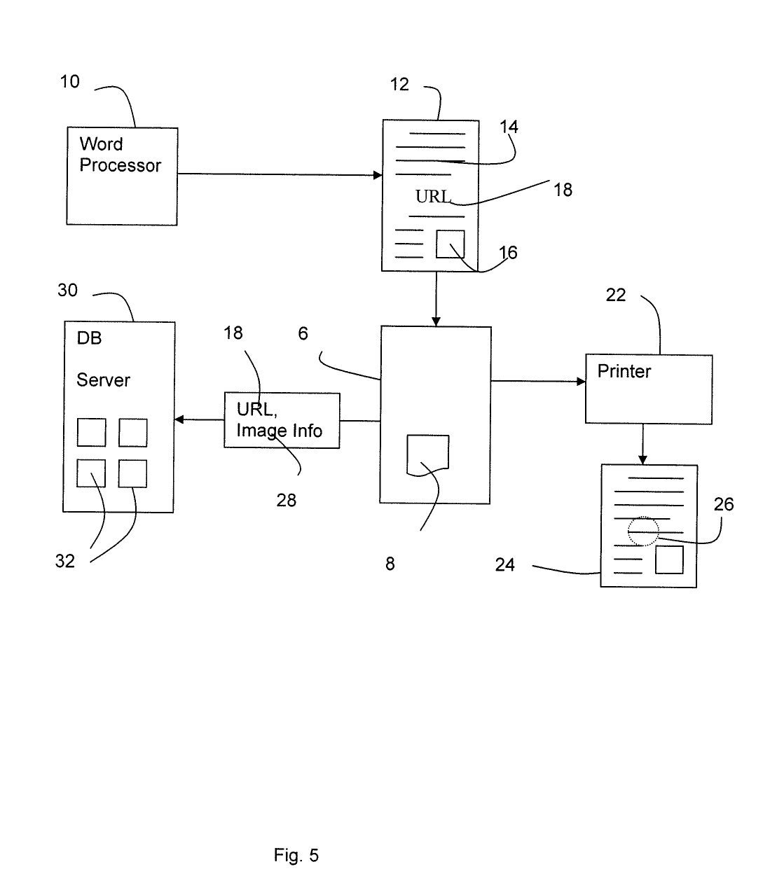

In a still further embodiment, illustrated in FIG. 5, the step of extraction of image information is separated from the step of printing. In this case, the image information at the URL location is obtained directly from the electronic document and stored as a data record 32 including the image information and a respective URL.

In this embodiment, the means to extract image information is code 8 which causes a computer 6 to carry out the steps of obtaining the image information and the URL and for storing the document in the database. The computer 6 may be the same computer as used to create the electronic document using editor 10 or a different computer.

As before, the process of creating the data record 32 does not include in the electronic image any additional codes such as watermarks directly coding the image information. Instead, the electronic image is simply the natural image of the electronic document.

Subsequently, the electronic document is printed, exactly in the form the electronic document would normally be printed. Thus, any embedded URL information not shown in the visual image of the electronic document is simply not printed. Since no additional codes are included, the printing does not require any special drivers or software at all and completely standard print routines may be used.

The reader can then use a camera in a mobile telephone or other device to access the hyperlink from the printed document using database 30 in exactly the same way as the other embodiments set out above.

The camera 40 and browser 4 may be integrated in a single mobile device.

In alternative arrangements, the camera sends the image 40 to a separate device.

The links between the print driver 20 and server 30, and between the browser 44 and server may be wireless or wired links.

While specific embodiments have been described herein for purposes of illustration, various modifications will be apparent to a person skilled in the art and may be made without departing from the scope of the invention. In particular, the various components may be separate components or integrated components as is known to those skilled in the art.

We claim:

1. A method of creating hyperlinks, comprising:
creating an electronic document;
attaching URL information defining a URL hyperlink at a URL hyperlink location in the electronic document;
identifying image information relating to the features of the image of the electronic document at the URL hyperlink location;
storing in a database the URL information and the respective identified image information relating to the respective URL hyperlink location; and
wherein the image information includes only the image of the electronic document without added codes coding the URL hyperlink location.

2. A method according to claim 1, further comprising:
printing the electronic document as a printed document.

3. A method according to claim 2 wherein the step of printing the electronic document includes:
passing the electronic document to a print driver including at least one item of URL information at a respective URL hyperlink location;
capturing image information from the electronic image corresponding to the URL hyperlink location;
passing the captured image information and the URL information from the print driver to the database; and
passing the electronic image from the print driver to a printer to print.

4. A method according to claim 2 wherein the step of printing the electronic document includes:
passing the electronic document to a printer including at least one item of URL information at a respective URL hyperlink location;
creating an electronic image to print excluding the URL information;
capturing image information from the electronic image corresponding to the URL hyperlink location;
passing the captured image information and the URL information to the database from the printer; and
printing the electronic image.

5. A method according to claim 2 wherein the step of printing the electronic document is carried out after the steps of capturing the image information and storing the URL information in a database have been completed.

6. A method of reading hyperlinks from a document on a printed medium, comprising:
capturing an image of a region of printed medium as a captured image;
searching a database for image information matching the captured image, the database including URL information and image information relating to the features of the image of the printed document corresponding to the respective URL information;
returning URL information from the database corresponding to image information matching the captured image; and
accessing a URL hyperlink defined by the URL information.

7. A method according to claim 6 wherein the step of capturing an image of a region comprises capturing the image using the camera of a mobile device.

8. A method according to claim 7 wherein the mobile device further includes a browser, and the step of accessing the URL hyperlink accesses the URL hyperlink on the browser of the mobile device.

9. A method according to claim 8 further comprising passing the captured image to a web browser on a separate device.

10. Apparatus for creating hyperlinks, comprising:
a tool for creating an electronic document including at least one item of URL information at a respective URL hyperlink location;
a database for storing a plurality of data records each including URL information and respective identified image information relating to the respective URL hyperlink location
a means for identifying image information relating to the features of the image of the electronic document at the URL hyperlink location and creating at least one data record in the database including the at least one item of URL information and the respective image information;
wherein the image information included in the database includes only the image of the electronic document without added codes coding the URL hyperlink location.

11. Apparatus according to claim 10, further comprising:
a printer for printing the electronic document as a printed document.

12. Apparatus according to claim 10 wherein the apparatus further comprises a print driver for capturing image information from the electronic image corresponding to the URL hyperlink location, for passing the captured image information and the URL information to the database; and for passing the electronic image from the print driver to the printer to print.

13. Apparatus according to claim 11, wherein the printer is arranged to capture image information from the electronic image corresponding to the URL hyperlink location, to pass the captured image information and the URL information to the database when printing the electronic image.

14. Networked apparatus for reading hyperlinks from a document on a printed medium, comprising:
a camera for capturing an image of a region of printed medium as a captured image;
a database including a plurality of data records, each data record including URL information and image information relating to the features of the image of respective printed document corresponding to the respective URL information;
a processor for searching the database for image information matching the captured image and returning a matching data record, and accessing a URL hyperlink defined by the URL information in the matching data record.
